(19) United States
(12) Patent Application Publication
(10) Pub. No.: US 2006/0094262 A1
(43) Pub. Date: May 4, 2006

(54) Connector removal device

(75) Inventors: Darin Bookey, Meriden, CT (US); Lulzim Asipi, Watertown, CT (US); Luis Galarza, Wallingford, CT (US)

Correspondence Address: ALEX S. ESBER AND GEORGE A. MALLETTE, 2823 N. LEMON AVENUE, SARASOTA, FL, 34234, US

(73) Assignee: ALCATEL

(21) Appl. No.: 10/980,340

(22) Filed: Nov. 4, 2004

(51) Int. Cl. H01R 12/00

(52) U.S. Cl. 439/66; 235/492; 235/486

(57) ABSTRACT

A tool mountable to a connector is provided. The tool includes a first member having a first end, a second end and a cutout, and a second member having a first end, a second end and a cutout. A hinge positions the first member and the second member such that the cutout of the first member and the cutout of the second member define an open area. The hinge allows relative motion between the first member and the second member such that the first member and the second member alternatively reach an open position and a closed position. A biasing member urges the first member and the second member to the closed position.

### BACKGROUND OF THE INVENTION

1. Field of the Invention

This invention is directed to a tool usable with a connecting device mounted on a transmission cable. More specifically, this invention is directed to a tool to assist removing a connector, such as a backnut, from a transmission cable.

2. Description of Related Art

Conventional transmission cables used in radio frequency communications include coaxial cables. Coaxial cables include an outer conductor surrounding a longitudinal dielectric material, and an inner conductor. The outer conductor is corrugated to enhance flexibility, and is surrounded by an insulating sheath. In operation, connectors couple the coaxial cable with other pieces of communication equipment. Specifically, the cable is coupled to the communication equipment by exposing the cable's corrugated outer conductor and mounting a connector to the exposed conductor. The connector is then coupled with the communication equipment, thereby securely linking together the coaxial cable and the communication equipment.

In general, the connector is mounted to the cable's exposed outer conductor by introducing the connector over an exposed end of the cable, then sliding the connector longitudinally along the cable in a forward direction toward the opposite end until the connector reaches a desired position. The connector interacts with the cable's corrugations in such a manner that the connector is free to slide in only the forward direction toward the opposite end. However, because the connector can move in only the forward direction along the cable, removing the connector from the cable requires the cable to be cut. Specifically, the cable must be cut at a position in advance of the connector, then the connector is moved along the cable in the forward direction to the cut and, ultimately, the connector is removed from the cable.

Cutting the cable is highly undesirable and results in unwanted waste of materials and time. Thus, a need exists for a tool that allows a connector to be removed from a cable without cutting the cable.

### SUMMARY OF THE INVENTION

In a first aspect of the present invention, a tool is provided. The tool is mountable to a connector and includes a first member having a first end, a second end and a cutout, and a second member having a first end, a second end and a cutout. A hinge positions the first member and the second member such that the cutout of the first member and the cutout of the second member define an open area. The hinge allows relative motion between the first member and the second member such that the first member and the second member alternatively reach an open position and a closed position. A biasing member urges the first member and the second member to the closed position.

In another aspect of the invention, a communication system is provided. The communication system includes a cable and communication equipment. A connector connects the cable with the communication equipment. The connector has a first member having a first end, a second end and a cutout, and a second member having a first end, a second end and a cutout. A hinge positions the first member and the second member such that the cutout of the first member and the cutout of the second member define an open area. The hinge allows relative motion between the first member and the second member such that the first member and the second member alternatively reach an open position and a closed position. Additionally, a biasing member urges the first member and the second member to the closed position.

In yet another embodiment, a method of mounting a tool to a connector is provided. The method includes the steps of providing a first member having a first end, a second end and a cutout, and providing a second member having a first end, a second end and a cutout. The method further includes the step of positioning the first member and the second member such that the cutout of the first member and the cutout of the second member define an open area. The first member and the second member alternatively reach an open position and a closed position. The method further includes the step of urging the first member and the second member to a predetermined position.

In a further embodiment, a tool in combination with a connector for attaching the connector to a coaxial cable is provided. The cable has an inner conductor, a dielectric insulator surrounding the inner conductor and a corrugated outer conductor. The connector includes a collet having a plurality of resilient fingers extending in a first direction, and an outer body. The outer body surrounds the collet and is movable therealong between an extended position in which the resilient fingers are expandable outwardly, and a retracted position in which the resilient fingers are restrained from expanding outwardly. The outer body is mateable with another connector. In the extended position the connector can move along the corrugated outer conductor in a forward direction and a reverse direction, and in the retracted position the connector can not move in the forward direction and the reverse direction. The tool comprises a retaining member attachable to the connector for retaining the collet in the extended position.

In yet another embodiment, a method for attaching a connector to a coaxial cable is provided. The cable includes an inner conductor, a dielectric insulator surrounding the inner conductor and a corrugated outer conductor. The connector includes a collet having a plurality of resilient fingers extending in a first direction, and an outer body surrounding the collet and movable therealong between an extended position in which the resilient fingers are expandable outwardly, and a retracted position in which the resilient fingers are restrained from expanding outwardly. The outer body is mateable with another connector. In the extended position the connector can move along the corrugated outer conductor in a forward direction and a reverse direction, whereas in the retracted position the connector can not move in the forward direction and the reverse direction. The method includes the step of retaining the collet in the extended position to allow the connector to be moved in the forward direction and the reverse direction.

### BRIEF DESCRIPTION OF THE DRAWINGS

FIG. 1 illustrates a side elevational view of a preferred embodiment of the present invention mounted to a connector on a cable.

FIG. 2 illustrates a side elevational view of the preferred embodiment of the present invention mounted to a connector.

FIG. 3 illustrates a front elevational view of the preferred embodiment of the present invention.

### DETAILED DESCRIPTION OF THE INVENTION

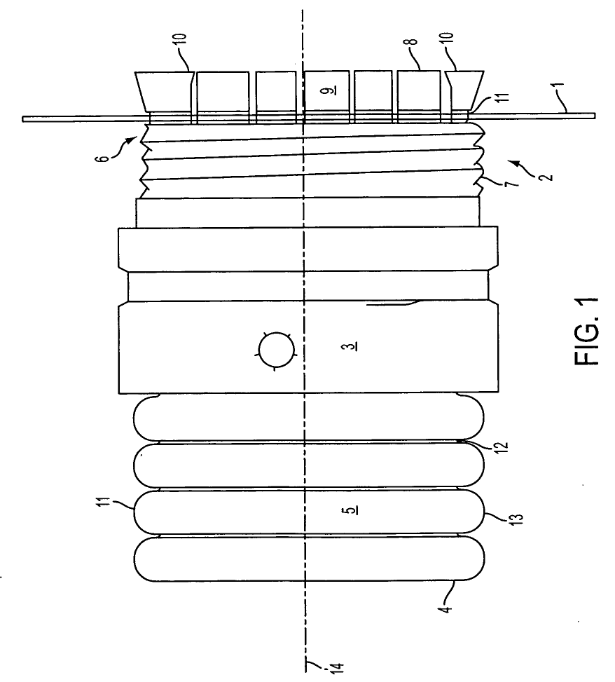

As explained below in detail, preferred embodiments of the present invention provide for simple and efficient removal of a connector, such as a backnut device, from a cable. The present invention includes the tool 1 illustrated in FIGS. 1-3. The tool 1 is removably mounted on the body 2 of a connector 3 such that the connector 3 may be moved in both a forward and a reverse direction along a cable 4. See, FIG. 1. Of course, the invention is not limited solely to the specific embodiments and features described below, and the embodiments and features discussed below may be modified without departing from the present invention.

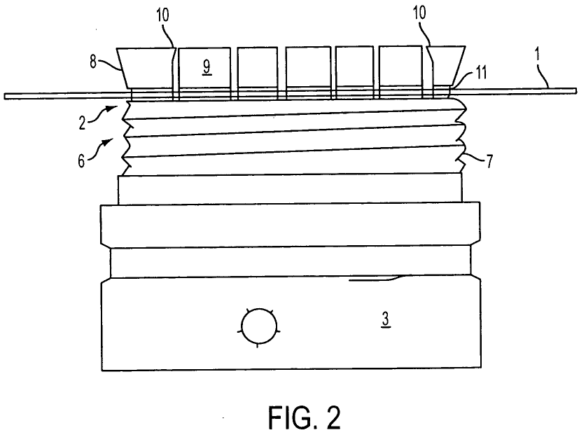

FIG. 1 illustrates the connector 3 mounted to the cable 4. The cable 4 includes a corrugated outer conductor 5 which may be surrounded by an outer insulating sheath (not shown). The outer insulating sheath is removed for installation of the connector 3. As shown in FIGS. 1 and 2, the connector 3 includes the body 2 with a leading end 6 having external threads 7 for mating with another connector. Disposed co-axially and partially within the body 2 is a collet 8 having resilient fingers 9 extending partially beyond the leading end 6 of the body 2. The resilient fingers 9 are flexible extensions including a distal end having an enlarged portion 10 and a face 11. The enlarged portion 10 is configured to extend into troughs 12 of the corrugations in the outer conductor 5, and the resilient fingers 9 are sufficiently flexible that the resilient fingers 9 may deflect and permit the enlarged portion 10 to ride over peaks 13 of the corrugations as the connector 3 moves along the cable 4 in a forward direction—to the left in FIG. 1.

In more detail, the collet 8 is allowed sufficient axial movement within the body 2 such that, in an extended position (FIG. 1), the resilient fingers 9 extend relatively far beyond the leading end 6 of the body 2. The resilient fingers 9 are thereby free to move radially to the longitudinal axis 14 of the cable 4. The longitudinal axis 14 is illustrated in FIG. 1. When the body 2 of the connector 3 is urged along the cable 4 in the forward direction away from the resilient fingers 9, the resilient fingers 9 ride over the peaks 13 of the outer conductor 5's corrugations as the connector 3 moves along the cable 4. The connector 3 is thereby moved in a forward direction along the cable 4. However, if the connector 3 is urged along the cable 4 in a reverse direction toward the resilient fingers 9, the body 2 moves relative to the collet 8 such that the body 2 advances along the collet 8 and the collet 8 reaches a retracted position within the body 2. In the retracted position, the resilient fingers 9 extend a relatively short distance beyond the leading end 6, so that the leading end 6 of the body 2 restrains the resilient fingers 9 from expanding radially outwardly of the cable 4. In this manner the resilient fingers 9 are fixed in the troughs 12 of the outer conductor 5 and are prevented from riding over the peaks 13 of the outer conductor 5. The connector 3 is thereby prevented from moving in the reverse direction along the cable 4.

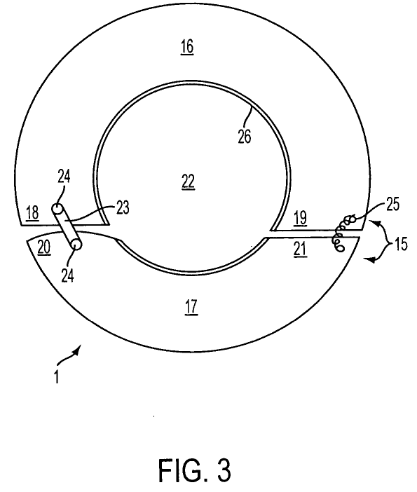

The tool 1 cooperates with the connector 3 to prevent the resilient fingers 9 from being constrained by the leading end 6 of the body 2, allowing the connector 3 to be moved along the cable 4 in both the forward and reverse directions. As shown in FIG. 3, the tool 1 includes a body 15 having a main plate 16 and a secondary plate 17. The main plate 16 has a first end 18 and a second end 19, and the secondary plate 17 has a first end 20 and a second end 21. Further, each of the main plate 16 and the secondary plate 17 has a cutout that is generally configured in an arc such that when the main plate 16 and the secondary plate 17 are disposed adjacent one another they define a generally circular space 22. The generally circular space 22 is the same size, or slightly larger, than the outer diameter of the collet 8. Additionally, an inner edge of the main plate 16 and the secondary plate 17 has a tapered contour 26 that generally reduces the thickness of the main plate 16 and the secondary plate 17. The contour 26 may extend entirely around the circumference of inner edge or may extend around only a portion of the circumference. In a preferred embodiment, each of the main plate 16 and the secondary plate 17 have a generally “C” shaped configuration that combine to form a ring shape, as shown in FIG. 3.

The main plate 16 and the secondary plate 17 are coupled together by a hinge 23. The hinge 23 positions the main plate 16 and the secondary plate 17 such that the cutout of the main plate 16 and the cutout of the secondary plate 17 define the generally circular space 22. The hinge 23 allows the main plate 16 and the secondary plate 17 to pivot about their respective first ends 18 and 20, while still maintaining positions that define the generally circular space 22, as shown in FIG. 3. In a preferred embodiment, the hinge 23 is constructed of a short length of metallic plate that spans the respective first ends 18 and 20 of the main plate 16 and the secondary plate 17. The hinge 23 is secured to the main plate 16 and the secondary plate 17 using pins 24. The pins 24 hold the hinge 23 such that the main plate 16 and the secondary plate 17 may rotate relatively to one another. Of course, it is understood that alternative hinge designs may be used, as discussed below.

For ease of manufacture, one or more of the main plate 16, the secondary plate 17 and the hinge 23 may be made of sheet metal. For example, the main plate 16, the secondary plate 17 and the hinge 23 may be 0.062 thick sheet metal. Of course the invention is not limited to such materials and dimensions, and the above noted components may be constructed of any other suitable material such as plastic or a metal alloy, and may have any other suitable dimensions.

As shown in FIG. 3, the second end 19 of the main plate 16 and the second end 21 of the secondary plate 17 are coupled together with a spring 25. The spring 25 biases the main plate 16 and the secondary plate 17 together, while still permitting relative movement about their respective first ends 18 and 20. The main plate 16 and the secondary plate 17 may thus be manually pivoted relative to one another to an open position at which the generally circular space 22 is relatively large. When the main plate 16 and the secondary plate 17 are not being manually manipulated, the spring 25 maintains the main plate 16 and the secondary plate 17 in a closed position making the generally circular space 22 relatively small.

Manually rotating the main plate 16 and the secondary plate 17 to the open position permits the tool 1 to be mounted to the connector 3. As previously noted, in the open position the generally circular space 22 becomes relatively large. The tool 1 may then be coupled with the connector 3 by sliding the tool 1 over the resilient fingers 9 and positioning the tool 1 such that the contour 26 contacts the face 11 of the resilient fingers 9. By this arrangement the resilient fingers 9 are at least partially seated within the contour 26. Thus, the tool 1 is disposed between the leading end 6 of the connector 3 and the face 11 of the resilient fingers 9, as shown in FIGS. 1 and 2. After the tool 1 is positioned, the spring 25 biases the main plate 16 and the secondary plate 17 to remain in a closed position. The tool 1 is thus securely held between the face 11 of the resilient fingers 9 and the leading end 6 of the connector 3. As shown in FIGS. 1 and 2, the tool 1 limits movement of the body 2 of the connector 3 relative to the collet 8 so that the collet 8 is retained in the extended position—i.e., the collet 8 cannot become retracted within the body 2. Consequently, the connector 3 does not constrain the resilient fingers 9 from moving perpendicularly to the longitudinal axis 14 of the cable 4 and the resilient fingers 9 remain free to ride over the peaks 13 of the corrugations. The connector 3 is thus free to be moved along the cable 4 in both the forward and reverse directions.

In operation, the tool 1 is secured to the connector 3 to retain the collet 8 in the extended position of FIG. 1. The cable 4 is prepared to receive the connector 3 by exposing the cable 4's corrugated outer conductor 5. The connector 3 is then positioned adjacent an exposed end of the cable 4, then moved in a forward direction over the exposed end of the outer conductor 5 and along the cable 4 to a desired position. The resilient fingers 9 extend beyond the leading end 6 of the body 2 such that the resilient fingers 9 are not prevented from riding over the peaks 13 of the corrugated outer conductor 5 as the connector 3 moves along the outer conductor 5. As previously noted, the tool 1 allows the connector 3 to also be moved in a reverse direction along the corrugated outer conductor 5. Specifically, when the body 2 of the connector 3 is urged in a direction toward the resilient fingers 9, the tool 1 prevents the body 2 of connector 3 from restraining the resilient fingers 9. Consequently, the connector 3 may be moved either forward or backward along the cable 4. Thus, if an operator wishes to remove the connector 4 from the cable, the operator does not need to cut the cable 4 at a position forward of the connector 3 in order to permit the connector 3 to slide off the cable 4. Instead, the tool 1 allows the operator to easily move the connector 3 in a backward direction along the cable 4 to the exposed end at which the connector 3 was originally introduced onto the cable 4.

When mounted to the cable 4, the connector 3 joins the cable 4 to other communication components. For example, the connector 3 may join the cable 4 to an antenna, base station equipment, or to any other equipment incorporated into a communication system.

Features of the present invention have been described above with respect to a preferred embodiment. The invention is not limited to such an embodiment and other embodiments are also within the scope of the invention. For example, in an alternative embodiment the tool 1 is formed from one continuous piece of flexible material, such as a suitable plastic, and is configured in a generally “C” like shape. In such an embodiment there is no need for the hinge 23, pins 24 and spring 25. Instead, the flexible material is sufficiently resilient that the operator may separate the open ends of the tool 1 such that the tool 1 is in an open position when the tool 1 is mounted or removed from the connector 3. The resilient material then maintains the open ends of the tool 1 in a closed position when the operator is not urging the open ends of the tool 1 apart. Of course, the tool 1 may be formed from a flexible material other than plastic, and may be configured in something other than a “C” shape such as a ring shape with a small removed section allowing the annulus to be twisted open. Thus, any materials which permit an operator to urge the tool 1 into open position, and which maintain the tool 1 in a closed position when not in the open position, are acceptable.

In yet another embodiment, the spring 25 may be located adjacent the hinge 23, spanning the respective first ends 18 and 20 of the main plate 16 and the secondary plate 17. In this configuration, the spring 25 may be positioned between the circular space 22 and the hinge 23 such that the spring 25 is in tension when the main plate 16 and secondary plate 17 are in the open position. The spring 25 may also be positioned such that the hinge 23 is located between the spring 25 and the circular space 22 and the spring 25 is in compression when the main plate 16 and secondary plate 17 are in the open position. Further, the spring may be designed into the hinge in a conventional manner.

Although specific embodiments of the present invention have been described above in detail, it will be understood that this description is merely for illustration purposes. Various modifications of and equivalent structure corresponding to the disclosed aspects of the preferred embodiments in addition to those described above may be made by those skilled in the art without departing from the present invention which is defined in the following claims. The scope of the claims is to be accorded the broadest interpretation so as to encompass such modifications and equivalent structures.

What is claimed is:

1. A tool mountable to a connector, comprising:
a first member having a first end, a second end and a cutout;
a second member having a first end, a second end and a cutout;
a hinge positioning said first member and said second member such that the cutout of said first member and the cutout of said second member define an open area, and said hinge allowing relative motion between said first member and said second member such that said first member and said second member alternatively reach an open position and a closed position; and
a biasing member urging said first member and said second member to the closed position.

2. The tool recited in claim 1, wherein the size of the open area changes during relative movement of said first member and said second member.

3. The tool recited in claim 2, wherein the size of the open area is smaller when said first member and said second member is in the closed position than when said first member and said second member are in the open position.

4. The tool recited in claim 1, wherein at least one of said first member and said second member have an inner edge with a contour.

5. The tool recited in claim 1, wherein said biasing member is formed continuously with said first member and said second member.

6. The tool recited in claim 1, wherein said biasing member is mounted to the second end of said first member and the second end of said second member.

7. A communication system, comprising:
a cable;
communication equipment; and
a connector connecting said cable with said communication equipment, said connector having:
a first member having a first end, a second end and a cutout;
a second member having a first end, a second end and a cutout;
a hinge positioning said first member and said second member such that the cutout of said first member and the cutout of said second member define an open area, and said hinge allowing relative motion between said first member and said second member such that said first member and said second member alternatively reach an open position and a closed position; and
a biasing member urging said first member and said second member to the closed position.

8. The communication system recited in claim 7, wherein said communication equipment includes at least one of an antenna and base station equipment.

9. The communication system recited in claim 7, wherein the size of the open area changes during relative movement of said first member and said second member.

10. The communication system recited in claim 7, wherein said hinge is formed continuously with said first member and said second member.

11. The communication system recited in claim 7, wherein said biasing member is mounted to the second end of said first member and the second end of said second member.

12. A method of mounting a tool to a connector, said method comprising the steps of:
providing a first member having a first end, a second end and a cutout;
providing a second member having a first end, a second end and a cutout;
positioning the first member and the second member such that the cutout of the first member and the cutout of the second member define an open area, and the first member and the second member alternatively reach an open position and a closed position; and
urging the first member and the second member to a predetermined position.

13. The method recited in claim 12, further comprising the steps of:
rotating at least one of the first member and the second member such that the first member and the second member reach an open position; and
mounting the tool to a connector.

14. A tool in combination with a connector for attaching the connector to a coaxial cable having an inner conductor, a dielectric insulator surrounding the inner conductor and a corrugated outer conductor, wherein the connector comprises:
a collet having a plurality of resilient fingers extending in a first direction; and
an outer body surrounding said collet and movable therealong between an extended position in which said resilient fingers are expandable outwardly and a retracted position in which said resilient fingers are restrained from expanding outwardly, said outer body being mateable with another connector, wherein in the extended position said connector can move along the corrugated outer conductor in a forward direction and a reverse direction, whereas in the retracted position said connector can not move in the forward direction and the reverse direction,
and wherein the tool comprises:
a retaining member attachable to the connector for retaining said collet in the extended position.

15. A tool in combination with a connector as recited in claim 14, wherein said retaining member comprises an annular member having an open end and defining an aperture therein for receiving the connector.

16. A tool in combination with a connector as recited in claim 15, wherein said annular member is moveable between an open position and a closed position, wherein said annular member is attachable to said connector when said annular member is in the open position and wherein said annular member retains said collet in the extended position when in the closed position.

17. A tool in combination with a connector as recited in claim 16, wherein said annular member includes a two substantially semi-arcuate members and wherein said retaining member further comprises a hinge for pivotally attaching said semi-arcuate members to each other at first ends thereof.

18. A tool in combination with a connector as recited in claim 17, wherein said retaining member further comprises a spring for urging said semi-arcuate members toward the closed position.

19. A tool in combination with a connector as recited in claim 18, wherein said spring is attached to second ends of said semi-arcuate members respectively opposite said first ends.

20. A method for attaching a connector to a coaxial cable having an inner conductor, a dielectric insulator surrounding the inner conductor and a corrugated outer conductor, the connector comprising a collet having a plurality of resilient fingers extending in a first direction; and an outer body surrounding the collet and movable therealong between an extended position in which the resilient fingers are expandable outwardly and a retracted position in which the resilient fingers are restrained from expanding outwardly, the outer body being mateable with another connector, wherein in the extended position the connector can move along the corrugated outer conductor in a forward direction and a reverse direction, whereas in the retracted position the connector can not move in the forward direction and the reverse direction, said method comprising the following step:
retaining the collet in the extended position to allow the connector to be moved in the forward direction and the reverse direction.
